(19) United States
(12) Patent Application Publication
(10) Pub. No.: US 2018/0375726 A1
(43) Pub. Date: Dec. 27, 2018

(54) Resource Configuration Method, Virtualized Network Function Manager, and Element Management System

(71) Applicant: Huawei Technologies Co., Ltd., Shenzhen (CN)

(72) Inventor: Haitao Xia, Beijing (CN)

(21) Appl. No.: 16/120,028

(22) Filed: Aug. 31, 2018

Related U.S. Application Data
(63) Continuation of application No. PCT/CN2016/075284, filed on Mar. 2, 2016.

(51) Int. Cl. H04L 12/24; H04L 12/26

(52) U.S. Cl. CPC H04L 41/0816; H04L 41/20; H04L 43/0817

(57) ABSTRACT

This disclosure relates to the field of communications technologies, and in particular, to a virtualization resource management technology in Network Functions Virtualization (VNF). In a resource configuration method, after obtaining a performance parameter that reflects a running status of a Network Functions Virtualization (VNF) instance, a VNFM determines, based on a mapping relationship between the performance parameter and a deployment flavor in a descriptor file corresponding to the VNF instance, a target deployment flavor that is suitable to be configured for the VNF instance in the running status, and performs resource configuration for the VNF instance based on a currently configured deployment flavor of the VNF instance and the target deployment flavor.

### CROSS-REFERENCE TO RELATED APPLICATIONS

This application is a continuation of International Patent Application No. PCT/CN2016/075284, filed on Mar. 2, 2016. The disclosure of the aforementioned application is hereby incorporated by reference in the entity.

### TECHNICAL FIELD

This disclosure relates to the field of communications technologies, and in particular, to a virtualization resource management technology in Network Functions Virtualization.

### BACKGROUND

Network Functions Virtualization (NFV) means that a telecommunication network operator implements some telecommunications network functions in general-purpose cloud servers, switches, and storage devices with reference to a virtualization technology in the information technology field, so as to implement fast and efficient deployment of a network service.

In a NFV management and orchestration (MANO) architecture defined by the European Telecommunications Standards Institute (ETSI), after creating a virtualized network function (VNF) instance, a virtualized network function manager (VNFM) may configure a VNF deployment flavor (DF) for the VNF instance, so that the VNF instance runs within a resource range deployed by the VNF deployment flavor, and a resource change range of a scaling operation of the VNF instance is also limited within the resource range deployed by the VNF deployment flavor. However, when a quantity of resources required for service processing of the VNF instance exceeds the resource range deployed by the deployment flavor configured for the VNF instance, if the VNF instance still runs within the resource range deployed by the originally deployed deployment flavor, an exception occurs in processing of a service of a terminal user by the VNF instance. For example, service quality of user data cannot be ensured, and therefore a running status of the VNF instance is affected.

### SUMMARY

In view of this, this disclosure provides a resource configuration method, a virtualized network function manager, and an element management system, so as to alleviate inability of a VNF instance to meet a service processing requirement.

According to one aspect, an embodiment of this disclosure provides a resource configuration method. In this method, after obtaining a performance parameter that reflects a running status of a VNF instance, a VNFM determines, based on a mapping relationship between the performance parameter and a deployment flavor in a descriptor file corresponding to the VNF instance, a target deployment flavor that is suitable to be configured for the VNF instance in the running status. The VNFM also performs resource configuration for the VNF instance based on a currently configured deployment flavor of the VNF instance and the target deployment flavor, so as to configure a deployment flavor that matches the running status of the VNF instance for the VNF instance, and perform resource configuration for the VNF more properly. In this way, a resource range specified by the deployment flavor configured for the VNF instance can meet a running requirement of the VNF instance, thereby ensuring a normal running status of the VNF instance.

In a possible design, that the VNFM performs resource configuration for the VNF instance based on the currently configured deployment flavor of the VNF instance and the target deployment flavor may be: when the currently configured deployment flavor of the VNF instance is different from the target deployment flavor, changing, by the VNFM, the deployment flavor configured for the VNF instance from the current deployment flavor to the target deployment flavor, so as to avoid generating a repeated configuration action when the target deployment flavor is the same as the currently configured deployment flavor of the VNF instance, thereby reducing a data processing amount.

In a possible design, the performance parameter obtained by the VNFM may be a performance indication parameter of the VNF instance, the performance indication parameter includes a monitored value, and the performance indication parameter indicates a performance running status of an application layer of the VNF instance. Correspondingly, the mapping relationship between the performance parameter and the deployment flavor includes at least one monitored value corresponding to each deployment flavor of a plurality of deployment flavors that can be selected by the VNF instance or a range of the monitored value.

In a possible design, the performance parameter obtained by the VNFM may be virtual resource usage of the VNF instance (for example, usage of virtual computing resources, virtual storage resources, and virtual network resources). Correspondingly, the mapping relationship between the performance parameter and the deployment flavor includes a value range of the virtual resource usage corresponding to each deployment flavor of the plurality of deployment flavors that can be selected by the VNF instance.

In a possible design, after configuring the deployment flavor of the VNF instance as the target deployment flavor, the VNFM may send a notification message to a network functions virtualization orchestrator NFVO and/or an EMS, where the notification message is notifies the NFVO and/or the EMS that the currently configured deployment flavor of the VNF instance is changed to the target deployment flavor.

According to another aspect, this disclosure provides another resource configuration method. In this method, after obtaining a performance parameter that reflects a running status of a VNF instance (for example, a performance indication parameter of the VNF instance, where the performance indication parameter includes a monitored value; or virtual resource usage of the VNF instance), an EMS determines, based on a mapping relationship between the performance parameter of the VNF and a required resource range, a target resource range required by the VNF instance in the running status, and determines, based on the target resource range and a currently configured deployment flavor of the VNF instance, whether to send a flavor change request to a VNFM, so as to request the VNFM to change the deployment flavor of the VNF instance to a target deployment flavor that has a corresponding resource range when the currently configured deployment flavor of the VNF does not meet a resource requirement. In this way, in the running status of the VNF instance, a resource range specified by the deployment flavor configured for the VNF can meet a running requirement of the VNF instance, thereby ensuring a normal running status of the VNF instance.

In a possible design, that the EMS determines, based on a mapping relationship between the performance parameter and a deployment flavor, the target deployment flavor that needs to be configured for the VNF instance in a current performance running status may be sending a flavor change request to the VNFM when the target deployment flavor is different from the currently configured deployment flavor of the VNF instance, where the flavor change request is used to request to change the deployment flavor of the VNF instance to the target deployment flavor.

According to still another aspect, an embodiment of the present invention provides a VNFM, and the VNFM has a function of implementing an actual VNFM behavior in the foregoing methods. The function may be implemented by hardware, or may be implemented by hardware by executing corresponding software. The hardware or the software includes one or more modules corresponding to the foregoing function.

In a possible design, the VNFM includes a communications interface and a processor, and the processor is configured to support the VNFM in performing the corresponding function in the foregoing methods. The communications interface is configured to support the VNFM in obtaining the performance parameter and the mapping relationship in the foregoing methods. The VNFM may further include a memory, and the memory is configured to be coupled to the processor, and stores a program instruction and data that are necessary for the VNFM.

According to yet another aspect, an embodiment of this disclosure further provides an EMS, and the EMS has a function of implementing an actual EMS behavior in the foregoing methods. The function may be implemented by hardware, or may be implemented by hardware by executing corresponding software. The hardware or the software includes one or more modules corresponding to the foregoing function.

In a possible design, the EMS includes a communications interface and a processor, and the processor is configured to support the EMS in performing the corresponding function in the foregoing methods. The communications interface is configured to support the EMS in obtaining the performance parameter in the foregoing methods, and configured to support the EMS in sending the flavor change request in the foregoing methods. The EMS may further include a memory, and the memory is configured to be coupled to the processor, and stores a program instruction and data that are necessary for a database server.

### BRIEF DESCRIPTION OF THE DRAWINGS

To describe the technical solutions in the embodiments of this disclosure more clearly, the following briefly describes the accompanying drawings required for describing the embodiments. Apparently, the accompanying drawings in the following description show merely some embodiments of this disclosure, and a person of ordinary skill in the art may still derive other drawings from these accompanying drawings without creative efforts.

FIG. 1 shows an architectural diagram of an embodiment of a possible network functions virtualization (NFV) system according to this disclosure;

FIG. 2 shows a schematic flowchart of an embodiment of a resource configuration method according to this disclosure;

FIG. 3 shows a possible schematic communication interaction diagram of an embodiment of a resource configuration method according to this disclosure;

FIG. 4 shows another possible schematic communication interaction diagram of an embodiment of a resource configuration method according to this disclosure;

FIG. 5 shows a schematic flowchart of an embodiment of another resource configuration method according to this disclosure;

FIG. 6 shows a schematic flowchart of an embodiment of another resource configuration method according to this disclosure;

FIG. 7 shows a possible schematic structural diagram of an embodiment of a virtualized network function manager according to this disclosure; and

FIG. 8 shows a possible schematic structural diagram of an embodiment of an element management system according to this disclosure.

### DETAILED DESCRIPTION OF ILLUSTRATIVE EMBODIMENTS

A system architecture described in the embodiments of the present invention is intended to describe the technical solutions of the embodiments of the present invention more clearly, and do not constitute any limitation to the technical solutions provided in the embodiments of the present invention. A person of ordinary skill in the art may know that, with evolution of the system architecture and emergence of a new service scenario, the technical solutions provided in the embodiments of the present invention are also applicable to similar technical problems.

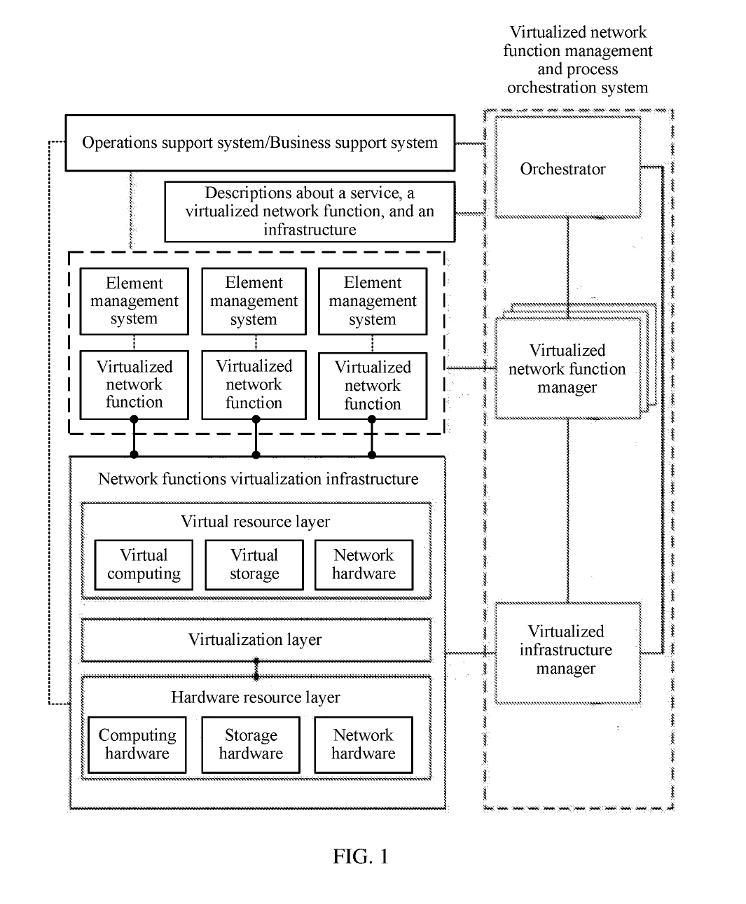

FIG. 1 is an architectural diagram of an embodiment of a network functions virtualization (NFV) system according to this disclosure. A resource configuration method in this disclosure is mainly applied to the NFV system. As shown in FIG. 1, an architecture of the NFV system mainly includes the following several function components: operations support system (OSS)/business support system (BSS), which is configured to initiate a service request and provide a resource required for a service to a network functions virtualization orchestrator (NFVO), and is responsible for troubleshooting. The NVF system also includes the NFVO, which is responsible for implementing an NFV service based on a service request of the OSS/BSS, and responsible for life cycle management of a network service (NS), resource orchestration and management, and real-time monitoring of a network functions virtualization infrastructure (NFVI resource and running status information. The NFVO implements life cycle management of a virtualized network function (VNF) and a global view of the resources in cooperation with a virtualized network function manager (VNFM). The NVF system also includes the VNFM, which is responsible for life cycle management of the VNF, for example, initialization of a VNF instance, scaling of the VNF instance, termination of the VNF instance, and management of VNF running status information. The NVF system also includes the virtualized infrastructure manager (VIM), which is responsible for management, monitoring, and fault reporting of hardware resources and virtualization resources of an infrastructure layer, and provides a virtualization resource pool for an upper-layer application, for example, responsible for managing and allocating NFVI resources, and monitoring and collecting information about a running status of the NFVI. The NVF system also includes the element management system (EMS), which is responsible for fault management, configuration management, accounting management, performance management, and security management (FCAPS) of a network element, where the element management system is also referred to as an element manager (EM). The NVF system also includes the NFVI resources, which include a hardware resource, a virtual resource, and a virtualization layer, and include NFVI resources of all NFVI resource states, such as available/reserved/allocated NFVI resources. From a perspective of the VNF, the virtualization layer and the hardware resource are considered as an entity that can provide required virtual resources.

In the NFV system, the VNF is a software implementation of a network function (NF) that can run on the NFVI. The VNF is equivalent to an entity of a network node, and is expected to be delivered using only software that is independent of hardware. In the NFV system, the VNF and a physical network function (PNF) in a non-virtualized network are expected to have a same functional behavior and external interface.

After creating the VNF, the VNFM may configure a deployment flavor for the VNF. The deployment flavor (DF) is also referred to as a VNF deployment flavor, and reflects a deployment view of a VNF on a network functions virtualization infrastructure (for example, a virtualized data unit and a virtual machine). Description of the VNF Deployment Flavor by the European Telecommunications Standards Institute (ETSI) is as follows. The VNF DF defines deployable configuration of a virtualized data unit (VDU) and deployable configuration of a connection between virtualized data units in a VNF deployment view, and generally includes a minimum quantity and a maximum quantity of components that can instantiate the VNF from a virtualized data unit. In short, the deployment flavor specifies a range interval of available virtual resources of the VNF. After a deployment flavor is configured for the VNF instance, the scaling operation of the VNF is performed, so that a capacity change range of the VNF can be kept within a resource range limited by the deployment flavor configured for the VNF. However, when a resource range required by service processing of the VNF exceeds a maximum resource range specified by the deployment flavor, a service processing requirement of the VNF cannot be met.

The following further describes the embodiments of the present invention in detail based on the foregoing common problems related to the present invention.

An embodiment of the present invention provides a resource configuration method and a virtualized network function manager VNFM based on the method. The VNFM obtains a performance parameter that reflects a running status of a VNF instance (for example, a performance indication parameter and virtual resource usage). A target deployment flavor that needs to be configured to meet a requirement of service processing of the VNF instance in a running status of the VNF instance is determined based on a mapping relationship between the performance parameter and a deployment flavor in a descriptor file corresponding to the VNF instance, and resource configuration is performed for the VNF instance based on a currently configured deployment flavor of the VNF instance and the target deployment flavor, so that resource configuration is performed for the VNF instance more properly in a current running status of the VNF instance, and a resource range specified by the deployment flavor configured for the VNF instance can meet a running requirement of the VNF instance, thereby ensuring a normal running status of the VNF instance, and alleviating service exceptions.

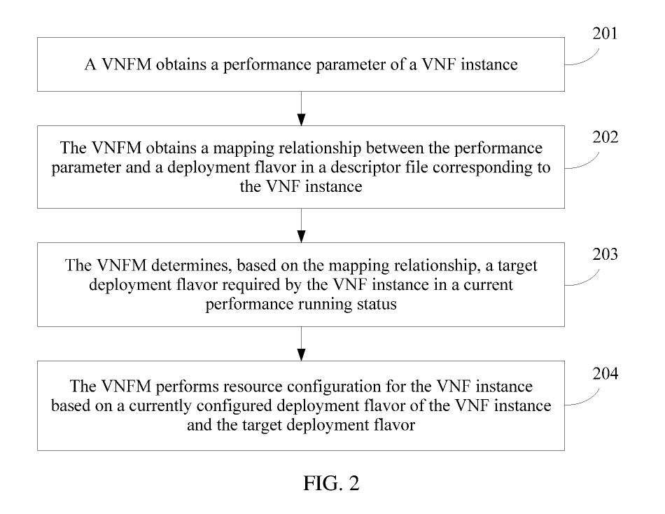

A solution of a resource configuration method provided in an embodiment of this disclosure is described below with reference to FIG. 2. As shown in FIG. 2, the resource configuration method provided in this embodiment of this disclosure may include the following steps.

S201. A VNFM obtains a performance parameter that reflects a running status of a virtualized network function VNF instance.

It may be understood that performance of the VNF instance may be reflected in a plurality of aspects, such as a service processing speed, a resource usage status, and an application layer running status. Accordingly, the performance parameter may have a plurality of possible cases.

In an example, the performance parameter may be a performance indication parameter of the VNF instance. The performance indication parameter may be understood as a parameter of a VNF indicator that is commonly known in the field, and the performance indication parameter indicates a performance running status of an application layer of the VNF instance. The performance indication parameter includes at least one monitored value. The monitored value may be considered as a status value of the indicator. An actual performance running status of the application layer of the VNF instance may be reflected by the monitored value. A specific type and meaning of the performance indication parameter may be predetermined by a VNF provider. For example, the performance indication parameter may be a set of enumerated values that represent a running health index of the VNF application layer. For example, the monitored value of the performance indication parameter and a meaning thereof may include: green (indicating that an application layer running status is healthy), yellow (indicating that an application layer running status is sub-healthy), orange (indicating that an application layer running status is severely sub-healthy), and red (indicating that an application layer running status is unhealthy and serious performance deterioration occurs).

A manner of obtaining the performance indication parameter may be as follows. An element management system EMS sends the performance indication parameter of the VNF instance to the VNFM, or the VNF instance sends the performance indication parameter of the VNF instance to the VNFM.

In another example, the performance parameter may be virtual resource usage of the VNF instance, for example, CPU usage or network bandwidth usage.

A manner in which the VNFM obtains the virtual resource usage may be monitoring the virtual resource usage of the VNF instance using a virtualized infrastructure manager (VIM), and reporting the virtual resource usage to the VNFM by the VIM.

S202. The VNFM obtains a mapping relationship between the performance parameter and a deployment flavor in the descriptor file.

The descriptor file describes deployment flavors that need to be configured for performance parameters of the VNF instance within different ranges. Optionally, the mapping relationship may be written into the descriptor file in a design phase of the VNF. In this embodiment, the descriptor file may be understood as a VNF descriptor (VNFD). The VNFD is a deployment flavor file that is used to describe deployment and operation behavior requirements of a virtualized network function (VNF), and further includes descriptions about connectivity and a function interface of the VNF, and a requirement for virtualized resources. In this embodiment, the foregoing mapping relationship is written into the VNFD.

In an NFV system architecture, a VNF developer provides descriptor files corresponding to different types of VNF instances, one descriptor file may include one or more deployment flavors, and deployment flavors included in different descriptor files may be different. Therefore, a descriptor file corresponding to the VNF instance needs to be determined, so as to determine at least one deployment flavor that can be configured for the VNF instance and a range of a performance parameter corresponding to the at least one deployment flavor.

Optionally, before obtaining the mapping relationship in the descriptor file corresponding to the VNF instance, the VNFM may access the descriptor file corresponding to the VNF instance, so as to obtain the mapping relationship from the descriptor file. Further, before accessing the VNF instance, the VNFM may determine identification information of the VNF instance. For example, the VNFM obtains both the performance parameter of the VNF instance and an identifier of the VNF instance, and then accesses the descriptor file corresponding to the VNF instance based on the identifier of the VNF instance. The identification information of the VNF instance may be a name or a unique identifier of the VNF instance.

Corresponding to the possible cases of the foregoing performance parameter, in an example, the mapping relationship may include at least one monitored value corresponding to each deployment flavor in the at least one deployment flavor that can be selected by the VNF instance or a range of the monitored value. The descriptor file corresponding to the VNF instance describes the at least one deployment flavor that can be selected by the VNF instance, and a deployment flavor that is suitable for selection within different monitored values or different monitored value ranges of the performance indication parameter.

In another example, the mapping relationship may include a value range of virtual resource usage corresponding to each deployment flavor of a plurality of deployment flavors that can be selected by the VNF instance. For example, when the virtual resource usage is within a first value range, a deployment flavor that is suitable to be configured is a deployment flavor 1; or when the virtual resource usage is within a second value range, a deployment flavor that is suitable to be configured is a deployment flavor 2.

S203. The VNFM determines, based on the mapping relationship and the performance parameter that reflects the running status of the VNF instance, a target deployment flavor required by the VNF instance in the running status.

A deployment flavor that is suitable to be configured for the VNF instance in the current performance running status may be determined based on the mapping relationship in the descriptor file and a performance parameter that reflects a current running status of the VNF instance. For ease of differentiation, in this embodiment, the determined deployment flavor that is suitable for the VNF in the current performance running status is referred to as the target deployment flavor.

S204. The VNFM performs resource configuration for the VNF instance based on a currently configured deployment flavor of the VNF instance and the target deployment flavor.

In an example, if the currently configured deployment flavor of the VNF is different from the target deployment flavor, the VNFM may change the currently configured deployment flavor of the VNF instance to the target deployment flavor. For example, the VNFM deletes a binding relationship between the VNF instance and the currently bound deployment flavor of the VNF, and establishes a binding relationship between the VNF instance and the target deployment flavor. Correspondingly, if the currently configured deployment flavor of the VNF is the target deployment flavor, the currently configured deployment flavor of the VNF instance may be kept unchanged.

In another example, the VNFM does not need to consider whether the currently deployed deployment flavor of the VNF is the same as the target deployment flavor. After determining the target deployment flavor, the VNFM only needs to change the currently configured deployment flavor of the VNF instance to the target deployment flavor.

Configuring a deployment flavor for the VNF instance may be understood as establishing or storing a binding relationship between the VNF instance and the deployment flavor. In this way, the VNFM may allocate a resource for performing a task to the VNF instance based on a resource range corresponding to the deployment flavor configured for the VNF instance.

Optionally, after step 204, this embodiment of this disclosure may further include: sending, by the VNFM, a notification message to any one or more of an NFVO and the EMS, where the notification message instructs the VNFM to perform resource configuration for the VNF instance. Particularly, when the deployment flavor configured for the VNF instance by the VNFM is the target deployment flavor, the notification message notifies any one or more of the NFVO and the EMS that the currently configured deployment flavor of the VNF instance is changed to the target deployment flavor.

In this embodiment of this disclosure, after obtaining the performance parameter that reflects the running status of the VNF instance, the VNFM determines, based on the mapping relationship between the performance parameter and the deployment flavor in the descriptor file corresponding to the VNF instance, a target deployment flavor that is suitable to be configured in the running status of the VNF instance, so as to configure, for the VNF instance, a deployment flavor that matches the running status of the VNF instance, and perform resource configuration for the VNF more properly. In this way, a resource range specified by the deployment flavor configured for the VNF instance can meet a running requirement of the VNF instance, thereby ensuring a normal running status of the VNF instance.

Optionally, before step 204, this embodiment of this disclosure may further include: determining the currently configured deployment flavor of the VNF instance, for example, determining, based on the identification information of the VNF instance, a deployment flavor that is currently bound to the identification information.

It should be noted that when it is determined that the currently configured deployment flavor of the VNF instance is different from the target deployment flavor, and the deployment flavor configured for the VNF instance needs to be changed, it may also be considered to change the deployment flavor of the VNF instance to the target deployment flavor by terminating the VNF instance and then creating a new VNF instance and configuring the target deployment flavor for the newly created VNF instance. However, a process from terminating the VNF instance to creating the new VNF instance is relatively time-consuming, and leads to an excessively long service interruption time. However, the binding relationship between the VNF instance and the deployment flavor is directly changed without terminating the VNF instance, so that a service interruption probability can be reduced, thereby ensuring a running status of the VNF instance.

The following further describes the embodiments of the present invention with reference to more accompanying drawings.

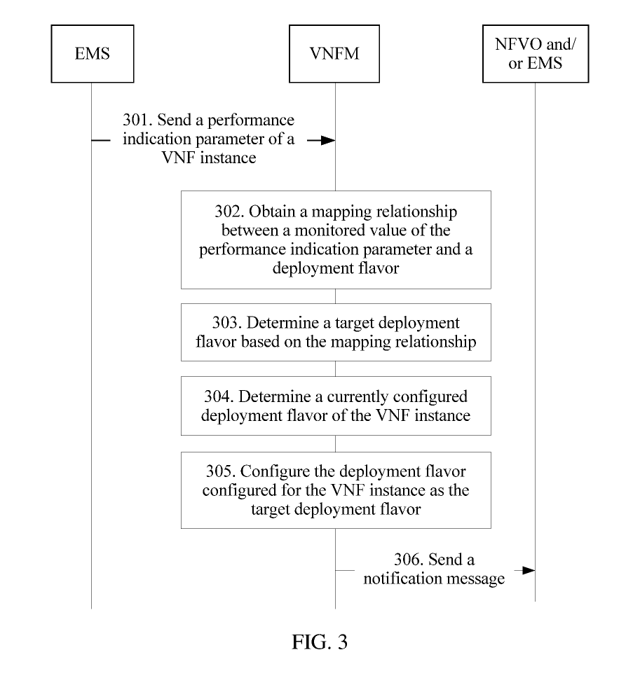

An example in which a performance parameter is a performance indication parameter of a VNF instance is used to describe a resource configuration method in an embodiment of this disclosure. As shown in FIG. 3, FIG. 3 shows a schematic communication interaction diagram of a resource configuration method according to an embodiment of the present invention.

In step 301, an EMS sends identification information of the VNF instance and the performance indication parameter of the VNF instance to a VNFM, where the performance indication parameter includes a monitored value.

The EMS may monitor a change status of the performance indication parameter in the VNF instance, to obtain the monitored value of the performance indication parameter of the VNF instance.

It should be noted that, in this embodiment, that the EMS sends the performance indication parameter to the VNFM is merely used as an example for description. However, the VNF instance may also obtain the identification information and the performance indication parameter that are of the VNF instance and send the identification information and the performance indication parameter to the VNFM.

In step 302, the VNFM queries, based on the identification information of the VNF instance, a database for a VNFD corresponding to the identification information of the VNF instance, and obtains a mapping relationship in the VNFD.

The VNFD describes one or more deployment flavors that can be selected by the VNF instance, and a deployment flavor corresponding to the performance indication parameter of different monitored values or in monitored value ranges.

Optionally, the performance indication parameter may further include a type of the performance indication parameter. For example, the “performance indication parameter indicating an enumerated value of a running health index of the VNF application layer” mentioned in the foregoing embodiment is a type of performance indication parameter. Certainly, there may be another type of performance indication parameter, for example, a type of performance indication parameter that indicates a response speed index of the application layer. Correspondingly, the mapping relationship may include a type of a performance indication parameter corresponding to each deployment flavor in the VNFD and one or more monitored values of the performance indication parameter or a range of the monitored value.

In step 303, the VNFM determines, based on the mapping relationship obtained in step 302, a target deployment flavor corresponding to the monitored value obtained in step 301.

In step 304, the VNFM determines a currently configured deployment flavor of the VNF instance.

Optionally, the VNFM may query for a binding relationship between the identification information of the VNF instance and identification information of the deployment flavor based on the identification information of the VNFM instance, and determine the identification information of the deployment flavor that is currently bound to the identification information of the VNF instance, so as to determine the currently configured deployment flavor of the VNF instance.

In step 305, when determining that the currently configured deployment flavor of the VNF instance is not the target deployment flavor, the VNFM changes the deployment flavor configured for the VNF instance to the target deployment flavor.

Step 305 may be the same as step 204 in FIG. 2, and details are not described herein again.

In step 306, the VNFM sends a notification message to an NFVO and/or the EMS, where the notification message notifies the VNF instance that the currently configured deployment flavor is changed to the target deployment flavor.

It should be noted that step 306 is optional, and a purpose of performing step 305 is merely to notify the NFVO and the EMS that the deployment flavor configured for the VNF instance is changed.

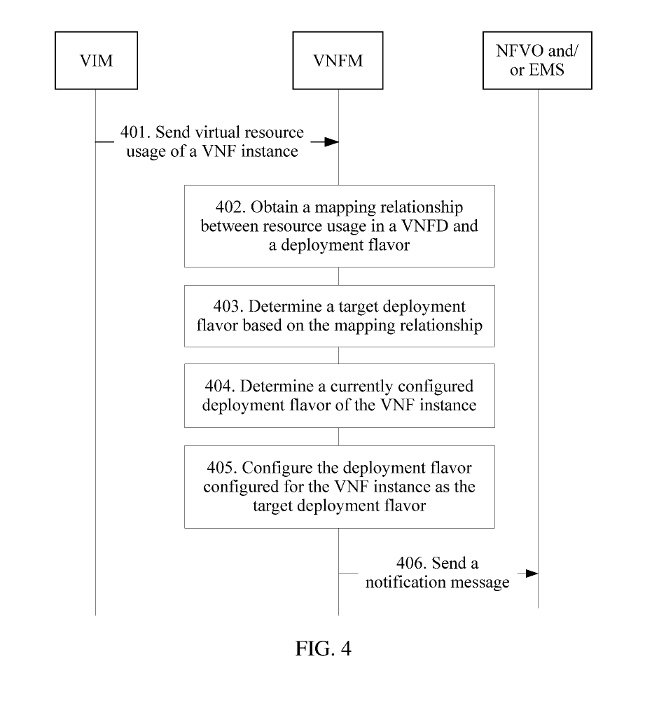

An example in which a performance parameter is virtual resource usage of a VNF instance is used to describe a resource configuration method in an embodiment of this disclosure. As shown in FIG. 4, FIG. 4 shows another schematic communication interaction diagram of a resource configuration method according to an embodiment of the present invention.

In step 401, a VIM sends identification information of the VNF instance and the virtual resource usage of the VNF instance to a VNFM.

For example, the virtual resource usage may be a ratio of a virtual resource occupied by current running of the VNF instance to a maximum quantity of available resources, for example, a ratio of memory occupied by current service processing of the VNF instance to maximum available memory of the VNF instance.

In step 402, the VNFM determines, based on the identification information of the VNF instance, a VNFD corresponding to the identification information of the VNF instance, and obtains a mapping relationship between each deployment flavor of a plurality of deployment flavors that can be selected by the VNFD and a value range of the virtual resource usage.

A requirement of the VNF instance for a virtual resource in a current running status may be reflected using the virtual resource usage. Therefore, deployment flavors suitable to be configured when the virtual resource usage of the VNF instance is within different ranges may be preconfigured.

In step 403, the VNFM determines, based on the mapping relationship between the deployment flavor and the value range of the virtual resource usage, a target deployment flavor corresponding to the virtual resource usage of the VNF instance.

In step 404, the VNFM determines a currently configured deployment flavor of the VNF instance.

In step 405, when determining that the currently configured deployment flavor of the VNF instance is not the target deployment flavor, the VNFM changes the deployment flavor configured for the VNF instance to the target deployment flavor.

In step 406, the VNFM sends a notification message to an NFVO and/or an EMS, where the notification message notifies the VNF instance that the currently configured deployment flavor is changed to the target deployment flavor.

Step 406 is optional.

Step 404, step 405, and step 406 in the embodiment in FIG. 4 may be respectively the same as step 304, step 305, and step 306 in the embodiment in FIG. 3, and a same part is not described again.

It may be understood that the VNFM may determine, based on both a monitored value of a performance indication parameter of the VNF instance and the virtual resource usage of the VNF instance, whether the deployment flavor configured for the VNF instance needs to be changed currently. Correspondingly, the mapping relationship in the VNFD may include the mapping relationship among the value range of the virtual resource usage, the monitored value of the performance indication parameter or a range of the monitored value, and the deployment flavor. After obtaining a value of the virtual resource usage of the VNF instance and the monitored value of the performance indication parameter of the VNF instance, the VNFD may determine the target deployment flavor based on the mapping relationship.

According to another aspect, an embodiment of this disclosure further provides another resource configuration method, and the resource configuration method may be applied to an EMS.

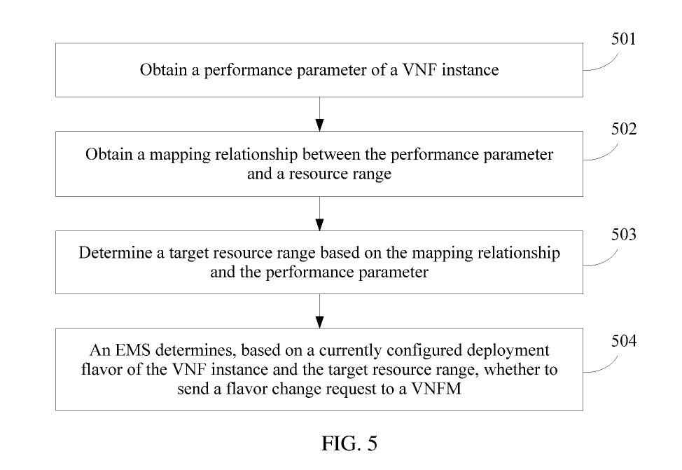

FIG. 5 shows a possible schematic flowchart of another resource configuration method according to an embodiment of this disclosure. As shown in FIG. 5, the another resource configuration method may include the following steps.

501. The EMS obtains a performance parameter that reflects a running status of a VNF instance.

The performance parameter is the same as the performance parameter in the foregoing resource configuration method.

For example, in a possible case, the performance parameter may be a performance indication parameter of the VNF instance. The performance indication parameter includes at least one monitored value of the performance indication parameter. A specific meaning of the monitored value of the performance indication parameter may be predetermined by a VNF provider.

For another example, in another possible case, the performance parameter may be virtual resource usage of the VNF instance, for example, CPU usage. The virtual resource usage of the VNF instance may be monitored by a virtualized infrastructure manager VIM, so that the virtual resource usage of the VNF instance can be obtained using the VIM. For example, the VIM sends the virtual resource usage of the VNF instance to the VNF instance or the EMS.

502. The EMS obtains a mapping relationship between the performance parameter of the VNF and a required resource range.

Optionally, the mapping relationship between the performance parameter of the VNF and the required resource range may be preconfigured in the EMS.

503. The EMS determines, based on the mapping relationship and the performance parameter that reflects the running status of the VNF instance, a target resource range required by the VNF instance in the running status.

In an example, the resource range in the mapping relationship may be a range interval that reflects a virtual resource requirement situation. Correspondingly, it is determined that the target resource range required by the VNF instance may be a range interval of the virtual resource, for example, required memory is a range interval from a to b.

In addition, with reference to different cases of the performance parameter, in a possible case, the mapping relationship may be specifically at least one monitored value of a performance indication parameter corresponding to each resource range interval of a plurality of resource range intervals that can be selected by the VNF instance or a range of the monitored value. For example, when the monitored value of the performance indication parameter is within a first range, it is suitable to select a first type of resource range interval. In another possible case, the mapping relationship may be specifically a value range of virtual resource usage corresponding to each resource range interval of a plurality of resource range intervals that can be selected by the VNF instance. For example, when the virtual resource usage is within a first value range, the required resource range is a first resource range interval.

In another example, considering that a deployment flavor is deployed with a range of a virtual resource that can be used by the VNF instance, different resource ranges may be reflected using the deployment flavor. Therefore, the resource range in the mapping relationship may be the deployment flavor. Correspondingly, determining the target resource range required by the VNF instance may be determining a target deployment flavor that is required in the running status of the VNF instance.

In addition, with reference to different cases of the performance parameter, in a possible case, the mapping relationship may be specifically at least one monitored value of a performance indication parameter corresponding to each deployment flavor in at least one deployment flavor that can be selected by the VNF instance or a range of the monitored value. In another possible case, the mapping relationship may be a value range of the virtual resource usage corresponding to each deployment flavor of a plurality of deployment flavors that can be selected by the VNF instance.

504. The EMS determines, based on a currently configured deployment flavor of the VNF instance and the target resource range, whether to send a flavor change request to a VNFM.

The flavor change request is used to request to change the deployment flavor of the VNF instance to a deployment flavor that has the target resource range.

For example, the EMS may send the flavor change request to the VNFM when the target resource range and a resource range specified by the currently configured deployment flavor of the VNF instance do not match.

For example, when the target resource range is a resource range interval, it may be detected whether a resource in the range interval is within the resource range deployed by the currently configured deployment flavor. Correspondingly, the flavor change request may carry information about the resource range interval. After receiving the flavor change request, the VNFM determines, based on the resource range interval carried in the flavor change request, the target deployment flavor that has the target resource range, and configures the deployment flavor of the VNF instance as the target deployment flavor.

When the target resource range is the target deployment flavor, the flavor change request may be sent to the VNFM when the currently configured deployment flavor of the VNF instance is different from the target deployment flavor, so as to request the VNFM to change the deployment flavor configured for the VNF instance to the target deployment flavor. For example, the flavor request may carry an identifier of the target deployment flavor, and after receiving the flavor change request, the VNFM deletes a binding relationship between the VNF instance and an identifier of the currently configured deployment flavor, and establishes a binding relationship between the VNF instance and the identifier of the target deployment flavor.

Optionally, before step 504, the EMS may further determine a currently configured deployment flavor of the VNF instance. In an implementation, the EMS may store information about the currently configured deployment flavor of the VNF instance, for example, store the identifier of the currently configured deployment flavor of the VNF instance and the resource range deployed by the deployment flavor. In another implementation, the EMS may send a query request to the VNFM in real time, to request the VNFM to feed back the currently configured deployment flavor of the VNF instance.

In this embodiment of this disclosure, after obtaining the performance parameter that reflects the running status of the VNF instance, the EMS determines, based on the mapping relationship between the performance parameter of the VNF and the required resource range, the target resource range required by the VNF instance in the running status. In this case, the EMS may determine, based on the currently configured deployment flavor of the VNF instance and the target deployment range, whether to send the flavor change request to the VNFM, to request the VNFM to configure a deployment flavor that has the target resource range for the VNF instance when the deployment flavor configured for the VNF instance cannot meet a current running requirement of the VNF instance, thereby alleviating inability of the VNF instance to meet a service processing requirement, and improving reliability of service processing of the VNF instance.

It should be noted that the another resource configuration method in FIG. 5 is described using an example in which an execution body is the EMS. However, the resource configuration method in FIG. 5 may also be applied to the VNF instance. A specific implementation process is similar to the process in which the execution body is the EMS, and details are not described herein again.

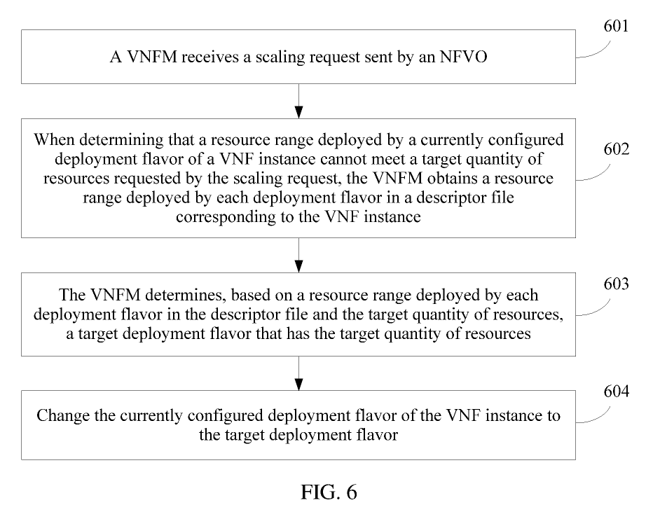

According to another aspect, an embodiment of this disclosure further provides another resource configuration method. As shown in FIG. 6, the another resource configuration method in this embodiment of this disclosure may include the following steps.

601. A VNFM receives a scaling request sent by an NFVO.

The scaling request carries identification information of a VNF instance and a target quantity of currently required resources.

For example, after determining, based on a service requirement, that a quantity of resources required by the VNF instance needs to be changed, an OSS/BSS may send a capacity change indication to the NFVO. In this case, after receiving the indication, the NFVO sends the scaling request to the VNFM based on the target quantity of resources that is indicated by the OSS/BSS and that is required by the VNF instance.

602. When determining that a resource range deployed by a currently configured deployment flavor of the VNF instance cannot meet the target quantity of resources requested by the scaling request, the VNFM obtains a resource range deployed by each deployment flavor in a descriptor file corresponding to the VNF instance.

The descriptor file may be understood as a VNFD. The descriptor file may include at least one deployment flavor that can be selected and configured for the VNF instance and a resource range deployed by each deployment flavor.

Optionally, before step 602, this embodiment of this disclosure may further include: determining, by the VNFM, a currently configured deployment flavor of the VNF instance. For example, the VNFM determines, based on the identification information of the VNF instance, the currently configured deployment flavor of the VNF instance. A specific manner of determining the currently configured deployment flavor of the VNF instance may be the same as the manner described in the embodiment of the foregoing resource configuration method, and details are not described herein again.

Optionally, before obtaining a resource range deployed by each deployment flavor in the descriptor file, the VNFM may access the descriptor file corresponding to the VNF instance, to obtain a resource range deployed by each deployment flavor in the descriptor file.

603. The VNFM determines, based on a resource range deployed by each deployment flavor in the descriptor file and the target quantity of resources, a target deployment flavor that has the target quantity of resources.

604. Change the currently configured deployment flavor of the VNF instance to the target deployment flavor.

Step 604 may be the same as the process in which the VNFM configures the target deployment flavor for the VNF instance in the foregoing embodiment.

Optionally, after step 604, this embodiment of this disclosure may further include: sending, by the VNFM, a notification message to any one or more of the NFVO and an EMS, where the notification message notifies any one or more of the NFVO and the EMS that the currently configured deployment flavor of the VNF instance is changed to the target deployment flavor.

In this embodiment of this disclosure, the VNFM may determine, based on the scaling request that is for the VNF instance and that is sent by the NFVO, whether the currently configured deployment flavor of the VNF instance can meet the target quantity of resources requested by the scaling request, and may change the deployment flavor configured for the VNF instance when the currently configured deployment flavor of the VNF instance cannot meet the target quantity of resources requested by the scaling request, to meet a service requirement.

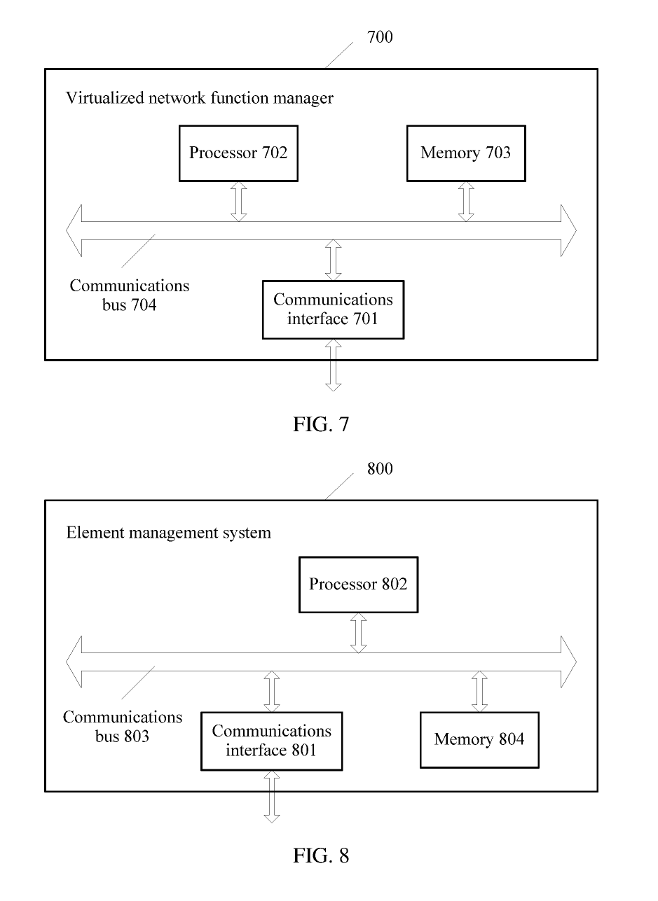

FIG. 7 shows a possible schematic structural diagram of a virtualized network function manager in the foregoing embodiments.

The virtualized network function manager 700 includes a communications interface 701 and a processor 702. The communications interface 701 is configured to: obtain a performance parameter that reflects a running status of a virtualized network function (VNF) instance, and obtain a mapping relationship between the performance parameter and a deployment flavor in a descriptor file corresponding to the VNF instance.

The processor 702 is configured to: determine, based on the mapping relationship and the performance parameter that reflects the running status of the VNF instance, a target deployment flavor required by the VNF instance in the running status; and perform resource configuration for the VNF instance based on a currently configured deployment flavor of the VNF instance and the target deployment flavor.

Certainly, the virtualized network function manager may further include a memory 703, and the memory 703 is configured to store program code and data that are used by the processor to perform the foregoing operations. The memory may be further configured to store a correspondence between the VNF instance and the currently configured deployment flavor of the VNF instance.

It may be understood that FIG. 7 shows only a simplified design of the virtualized network function manager. The virtualized network function manager 700 may further include a communications bus 704, and the communications interface, the processor, and the like may be connected using the communications bus.

Certainly, the virtualized network function manager may further include a memory, any quantity of controllers, a communications unit, and the like; and all virtualized network function managers that can implement the present invention fall within the protection scope of this disclosure.

Optionally, that the processor performs resource configuration for the VNF instance based on the currently configured deployment flavor of the VNF instance and the target deployment flavor is specifically: when the currently configured deployment flavor of the VNF instance is different from the target deployment flavor, changing the deployment flavor configured for the VNF instance from the current deployment flavor to the target deployment flavor.

Optionally, the communications interface may be further configured to access the descriptor file corresponding to the VNF instance before obtaining the mapping relationship between the performance parameter and the deployment flavor in the descriptor file corresponding to the VNF instance.

In a possible implementation, that the communications interface obtains the performance parameter that reflects the running status of the VNF instance is specifically obtaining a performance indication parameter of the VNF instance, where the performance indication parameter includes a monitored value, and the performance indication parameter is used to indicate a performance running status of an application layer of the VNF instance.

The mapping relationship that is between the performance parameter and the deployment flavor and that is obtained by the communications interface includes: at least one monitored value of the performance indication parameter corresponding to each deployment flavor of a plurality of deployment flavors that can be selected by the VNF instance or a range of the monitored value.

Optionally, that the communications interface obtains the performance indication parameter of the VNF instance is specifically obtaining the performance indication parameter that is of the VNF instance and that is sent by an element management system (EMS) of the VNF instance.

Optionally, the performance indication parameter obtained by the communications interface further includes a type of the performance indication parameter; and the mapping relationship that is between the performance parameter and the deployment flavor and that is obtained by the communications interface includes: the type of the performance indication parameter corresponding to each deployment flavor of the plurality of deployment flavors and one or more monitored values of the performance indication parameter or a range of the monitored value.

In another possible implementation, that the communications interface obtains the performance parameter that reflects the running status of the VNF instance is specifically obtaining virtual resource usage of the VNF instance.

The mapping relationship that is between the performance parameter and the deployment flavor and that is obtained by the communications interface includes: a value range of the virtual resource usage corresponding to each deployment flavor of the plurality of deployment flavors that can be selected by the VNF instance.

Optionally, that the communications interface obtains the virtual resource usage of the VNF instance includes: receiving the virtual resource usage that is of the VNF instance and that is sent by a virtualized infrastructure manager VIM.

Further, the communications interface is further configured to: after the processor configures the deployment flavor configured for the VNF instance as the target deployment flavor, send a notification message to a network functions virtualization orchestrator (NFVO) and/or an EMS, where the notification message notifies the NFVO and/or the EMS that the currently configured deployment flavor of the VNF instance is changed to the target deployment flavor.

Optionally, the mapping relationship between the performance parameter and the deployment flavor is written into the descriptor file of the VNF in a design phase of the VNF.

FIG. 8 shows a possible schematic structural diagram of an element management system in the foregoing embodiments.

The element management system 800 may include a communications interface 801 and a processor 802.

The communications interface 801 is configured to obtain a performance parameter that reflects a running status of a VNF instance.

The processor 802 is configured to: obtain a mapping relationship between the performance parameter of the VNF and a required resource range; determine, based on the mapping relationship and the performance parameter that reflects the running status of the VNF instance, a target resource range required by the VNF instance in the running status; and determine, based on a currently configured deployment flavor of the VNF instance and the target resource range, whether to send a flavor change request to a VNFM, where the flavor change request is used to request to change the deployment flavor of the VNF instance to a deployment flavor that has the target resource range.

The element management system may further include a communications bus 803, and the communications interface, the processor, and the like may be connected using the communications bus.

It may be understood that FIG. 8 shows only a simplified design of the element management system. The element management system may further include a memory 804, and the memory is configured to store program code and data that are used by the processor to perform the foregoing operation. The memory may be further configured to store the mapping relationship between the performance parameter and the resource range. Certainly, the element management system may further include a memory, any quantity of controllers, a communications unit, and the like, and all element management systems that can implement the present invention fall within the protection scope of this disclosure.

Optionally, the processor 802 is specifically configured to: when the target resource range and a resource range specified by the currently configured deployment flavor of the VNF instance do not match, control the communications interface to send the flavor change request to the VNFM.

Correspondingly, the communications interface is further configured to: when the target resource range and the resource range specified by the currently configured deployment flavor of the VNF instance do not match, send the flavor change request to the VNFM.

Optionally, that the processor obtains the mapping relationship is specifically: obtaining, by the processor, the mapping relationship between a preconfigured performance parameter of the VNF and the required resource range.

Optionally, the mapping relationship obtained by the processor 802 is specifically a mapping relationship that is between the performance parameter of the VNF and the deployment flavor and that is obtained by the element management system; and that the processor determines the target resource range is specifically determining, based on the mapping relationship and the performance parameter that reflects the running status of the VNF instance, a target deployment flavor that needs to be configured for the VNF instance in the running status.

Optionally, the performance parameter obtained by the communications interface 801 includes: a performance indication parameter of the VNF instance, where the performance indication parameter includes the monitored value, and the performance indicator is used to indicate a performance running status of an application layer of the VNF instance; or virtual resource usage of the VNF instance.

According to another aspect, an embodiment of this disclosure further provides another virtualized network function manager, and a composition structure of the virtualized network function manager is the same as the composition structure in FIG. 7.

A difference is that the communications interface 701 is configured to: receive a scaling request that is sent by an NFVO, where the scaling request carries identification information of the VNF instance and a target quantity of currently required resources; and obtain a resource range deployed by the currently configured deployment flavor of the VNF instance in a descriptor file corresponding to the VNF instance.

The processor 702 is configured to: when it is determined that the resource range deployed by the currently configured deployment flavor of the VNF instance cannot meet the target quantity of resources requested by the scaling request, obtain a resource range deployed by each deployment flavor in the descriptor file of the VNF instance; determine, based on a resource range deployed by each deployment flavor in the descriptor file and the target quantity of resources, a target deployment flavor that has the target quantity of resources; and change the currently configured deployment flavor of the VNF instance to the target deployment flavor.

Optionally, the processor may further determine the currently configured deployment flavor of the VNF instance, for example, determine, based on the identification information of the VNF instance, the currently configured deployment flavor of the VNF instance.

Optionally, before obtaining a resource range deployed by each deployment flavor in the descriptor file, the communications interface may be further configured to access the descriptor file corresponding to the VNF instance, so as to obtain a resource range deployed by each deployment flavor in the descriptor file.

The embodiments in this specification are all described in a progressive manner, for same or similar parts in the embodiments, reference may be made to these embodiments, and each embodiment focuses on a difference from other embodiments. The apparatus disclosed in the embodiments is described relatively simply because it corresponds to the method disclosed in the embodiments, and for portions related to those of the method, reference may be made to the description of the method.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular disclosures and design constraint conditions of the technical solutions. A person skilled in the art may use different methods to implement the described functions for each particular disclosure, but it should not be considered that the implementation goes beyond the scope of the present invention.

In combination with the embodiments disclosed in this specification, method or algorithm steps may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The embodiments disclosed above are described to enable a person skilled in the art to implement or use the present invention. Various modifications to the embodiments are obvious to the person skilled in the art, and general principles defined in this specification may be implemented in other embodiments without departing from the scope of the present invention. Therefore, the present invention will not be limited to the embodiments described in this specification but extends to the widest scope that complies with the principles and novelty disclosed in this specification.

What is claimed is:

1. A method, comprising:
obtaining, by a virtualized network function manager (VNFM), a performance parameter that reflects a running status of a virtualized network function (VNF) instance;
obtaining, by the VNFM, a mapping relationship between the performance parameter and a target deployment flavor in a descriptor file corresponding to the VNF instance;
determining, by the VNFM based on the mapping relationship and the performance parameter that reflects the running status of the VNF instance, the target deployment flavor, wherein the target deployment flavor is required by the VNF instance in the running status; and
performing, by the VNFM, resource configuration for the VNF instance based on a currently configured deployment flavor of the VNF instance and the target deployment flavor.

2. The method according to claim 1, wherein performing, by the VNFM, resource configuration for the VNF instance based on the currently configured deployment flavor of the VNF instance and the target deployment flavor comprises:
when the currently configured deployment flavor of the VNF instance is different from the target deployment flavor, changing, by the VNFM, the deployment flavor configured for the VNF instance from the currently configured deployment flavor to the target deployment flavor.

3. The method according to claim 1, wherein obtaining the performance parameter that reflects the running status of the VNF instance comprises:
obtaining, by the VNFM, a performance indication parameter of the VNF instance, wherein the performance indication parameter comprises a first monitored value, and the performance indication parameter indicates a performance running status of an application layer of the VNF instance; and
wherein the mapping relationship between the performance parameter and the target deployment flavor comprises:
a plurality of deployment flavors that correspond to a plurality of monitored values, wherein each of the plurality of deployment flavors corresponds to at least one of the plurality of monitored values, wherein each of the plurality of deployment flavors are selectable by the VNF instance, the plurality of monitored values includes the first monitored value, and the plurality of deployment flavors include the target deployment flavor; or
a plurality of deployment flavors that correspond to a plurality of monitored value ranges, wherein each of the plurality of deployment flavors corresponds to at least one of the monitored value ranges, wherein each of the plurality of deployment flavors are selectable by the VNF instance, and the plurality of deployment flavors include the target deployment flavor.

4. The method according to claim 3, wherein obtaining the performance indication parameter of the VNF instance comprises:
receiving, by the VNFM, the performance indication parameter of the VNF instance that is sent by an element management system (EMS) of the VNF instance.

5. The method according to claim 3, wherein the performance indication parameter further comprises a first performance indication type; and
wherein the mapping relationship between the performance parameter and the target deployment flavor comprises:
a plurality of performance indication types, wherein each deployment flavor of the plurality of deployment flavors further corresponds to at least one of the plurality of performance indication types, wherein the plurality of performance indication types includes the first performance indication type.

6. The method according to claim 1, wherein obtaining the performance parameter that reflects the running status of a VNF instance comprises:
obtaining, by the VNFM, virtual resource usage of the VNF instance; and
wherein the mapping relationship between the performance parameter and the deployment flavor comprises:
a plurality of deployment flavors that correspond to a plurality of value ranges of the virtual resource usage, wherein each of the plurality of deployment flavors corresponds to at least one of the plurality of value ranges of the virtual resource usage, wherein each of the plurality of deployment flavors are selectable by the VNF instance.

7. The method according to claim 6, wherein obtaining the virtual resource usage of the VNF instance comprises:
receiving, by the VNFM, the virtual resource usage of the VNF instance that is sent by a virtualized infrastructure manager (VIM).

8. The method according to claim 1, wherein before obtaining the mapping relationship between the performance parameter and the deployment flavor in the descriptor file corresponding to the VNF instance, the method further comprises:
accessing, by the VNFM, the descriptor file corresponding to the VNF instance.

9. The method according to claim 1, wherein the performance parameter is a VNF indicator.

10. A virtualized network function manager (VNFM), comprising:
a communications interface, configured to:
obtain a performance parameter that reflects a running status of a virtualized network function (VNF) instance; and
obtain a mapping relationship between the performance parameter and a target deployment flavor in a descriptor file corresponding to the VNF instance; and
a processor, configured to:
determine, based on the mapping relationship and the performance parameter that reflects the running status of the VNF instance, the target deployment flavor, wherein the target deployment flavor is required by the VNF instance in the running status; and
perform resource configuration for the VNF instance based on a currently configured deployment flavor of the VNF instance and the target deployment flavor.

11. The virtualized network function manager according to claim 10, wherein the processor is further configured to change the deployment flavor configured for the VNF instance from the current deployment flavor to the target deployment flavor when the currently configured deployment flavor of the VNF instance is different from the target deployment flavor.

12. The virtualized network function manager according to claim 11, wherein the communications interface is further configured to:
after the processor changes the deployment flavor configured for the VNF instance from the current configured deployment flavor to the target deployment flavor, send a notification message to a network functions virtualization orchestrator (NFVO) or an element management system (EMS), wherein the notification message notifies the NFVO or the EMS that the currently configured deployment flavor of the VNF instance has been changed to the target deployment flavor.

13. The virtualized network function manager according to claim 10, wherein the communications interface is configured to obtain a performance indication parameter of the VNF instance, wherein the performance indication parameter comprises a first monitored value, and the performance indication parameter indicates a performance running status of an application layer of the VNF instance; and
wherein the mapping relationship between the performance parameter and the target deployment flavor comprises:
a plurality of deployment flavors that correspond to a plurality of monitored values, wherein each of the plurality of deployment flavors corresponds to at least one of the plurality of monitored values, wherein each of the plurality of deployment flavors are selectable by the VNF instance, the plurality of monitored values includes the first monitored value, and the plurality of deployment flavors include the target deployment flavor; or
a plurality of deployment flavors that correspond to a plurality of monitored value ranges, wherein each of the plurality of deployment flavors corresponds to at least one of the monitored value ranges, wherein each of the plurality of deployment flavors are selectable by the VNF instance, and the plurality of deployment flavors include the target deployment flavor.

14. The virtualized network function manager according to claim 13, wherein the communications interface is configured to receive the performance indication parameter of the VNF instance that is sent by an element management system (EMS) of the VNF instance.

15. The virtualized network function manager according to claim 13, wherein the performance indication parameter further comprises a first performance indication type; and
wherein the mapping relationship between the performance parameter and the target deployment flavor comprises:
a plurality of performance indication types, wherein each deployment flavor of the plurality of deployment flavors further corresponds to at least one of the plurality of performance indication types, wherein the plurality of performance indication types includes the first performance indication type.

16. The virtualized network function manager according to claim 10, wherein the communications interface is further configured to obtain virtual resource usage of the VNF instance; and
wherein the mapping relationship between the performance parameter and the target deployment flavor comprises:
a plurality of deployment flavors that correspond to a plurality of value ranges of the virtual resource usage, wherein each of the plurality of deployment flavors corresponds to at least one of the plurality of value ranges of the virtual resource usage, wherein each of the plurality of deployment flavors are selectable by the VNF instance.

17. The virtualized network function manager according to claim 16, wherein the communications interface is configured to receive the virtual resource usage of the VNF instance that is sent by a virtualized infrastructure manager (VIM).

18. The virtualized network function manager according to claim 10, wherein the communications interface is further configured to access the descriptor file corresponding to the VNF instance before obtaining the mapping relationship between the performance parameter and the deployment flavor in the descriptor file corresponding to the VNF instance.

19. The virtualized network function manager according to claim 10, wherein the performance parameter is a VNF indicator.

20. A non-transitory computer-readable medium storing instructions which, when executed by one or more processors, cause the one or more processors to:
obtain a performance parameter that reflects a running status of a virtualized network function (VNF) instance;
obtain a mapping relationship between the performance parameter and a target deployment flavor in a descriptor file corresponding to the VNF instance;
determine, based on the mapping relationship and the performance parameter that reflects the running status of the VNF instance, the target deployment flavor, wherein the target deployment flavor is required by the VNF instance in the running status; and
performing resource configuration for the VNF instance based on a currently configured deployment flavor of the VNF instance and the target deployment flavor.
